(19) United States
(12) Patent Application Publication
(10) Pub. No.: US 2010/0328202 A1
(43) Pub. Date: Dec. 30, 2010

(54) INFORMATION DISPLAY DEVICE, INFORMATION DISPLAY METHOD, AND PROGRAM

(75) Inventor: Naoto Maeda, Tokyo (JP)

Correspondence Address: FOLEY AND LARDNER LLP;SUITE 500, 3000 K STREET NW, WASHINGTON, DC, 20007, US

(73) Assignee: NEC CORPORATION, Tokyo (JP)

(21) Appl. No.: 12/918,287

(22) PCT Filed: Feb. 19, 2009
(86) PCT No.: PCT/JP2009/052830

§ 371 Date: Aug. 18, 2010

(30) Foreign Application Priority Data
Feb. 19, 2008 (JP) 2008-037604

(51) Int. Cl. G09G 5/00

(52) U.S. Cl. 345/156

(57) ABSTRACT

An information display device, an information display method, and a program displays, when displaying definition information of an instance method selected by a user, definition information that corresponds to contents of processing of the instance method during runtime. The information display device displays definition information of an instance method selected by a user; wherein the instance method is included in a type that can be referenced during runtime by a variable that references a receiver object of the instance method.

### TECHNICAL FIELD

1. Cross-Reference to Related Application

This application claims the benefit of Japanese Patent Application No. 2008-037604, filed Feb. 19, 2008, which is hereby incorporated by reference herein in its entirety. This invention relates to an information display device, an information display method, and a program. More particularly, the invention relates to an information display device, an information display method, and a program for displaying information on an instance method that appears in a source code of a program described in an object-oriented language.

2. Background

An information display device is described in Non-Patent Document 1. As shown in FIG. 7, the information display device 110 described in the Non-Patent Document 1 comprises an input unit 111, a defined-type collection unit 112, an output unit 116, and a memory device 117. The memory device 117 stores defined-type information and a source code.

The information display device 110 operates in the following way. It is assumed that an editor in which a source code of a program is presented or edited is already running. The input 111 unit receives an input from a user through a mouse or keyboard. When a call of a specific instance method is selected that is included in a source code presented in the display and the input unit 111 receives an input that corresponds to a function of “Show Declaration” (for example input of the function key F3), the input unit 111 sends information of the instance method to the defined-type collection unit 112.

When the defined-type collection unit 112 receives the information of the instance method, the define-type collection unit 112 reads type information for a variable that references a receiver object of the received instance method from defined-type information stored in the memory device 117. Defined-type A is an example of defined-type information stored in the memory device 117. The defined-type information A can be generated, for example, by a method called type analysis. The defined-type collection unit 112 obtains type information for a variable that references a receiver object from the defined-type information A, obtains information (class definition) that correspond to the obtained type, and output definition information (method definition) of an instance method included in the class definition through the output unit 116.

Referring to a source code of a program shown in FIG. 8, an operation of the conventional information display device 110 is concretely explained. It is assumed that the source code is presented in an editor. It is also assumed that a user has selected for example “p.foo( )” in the fourth line and performed an input operation that calls a “Show Declaration” function. In this case, a variable p and an instance method foo( ) are sent from the input unit 111 to the defined-type collection unit 112.

The defined type collection unit 112 obtains a type that corresponds to the variable p from the defined-type information A. In the case of the source code shown in FIG. 8, it is determined that the type of the variable p is P through a type analysis. The defined-type collection unit 112 obtains a class definition of P from the source code and sends a method definition of the instance method foo( ) defined in the class information of P to the output unit 116. The output unit 116 provides the user with a method definition of the instance method foo( ) in the ninth line. In this way, the information display device 110 displays information on a instance method by using type information of a variable.

[Non-Patent Document 1] Shinji Miyamoto, “Fourth Time: A useful function of Eclipse” (on line), Feb. 9, 2005, impress IT corporation, [searched on Dec. 13, 2007], URL<http://thinkit.co.jp/free/tech/3/4/1.html>

### SUMMARY

It should be noted that the content disclosed in Non-Patent Document 1 is hereby incorporated by reference herein in its entirety. The following analysis has been made by the inventor. Referring to FIG. 8, a problem in the information display device 110 is explained. As described above, the information display device 110 displays a method definition of foo( ) in the ninth line as an information that corresponds to a call of an instance method p.foo( ) in the fourth line. However, during runtime of the program, an instance method actually called in the fourth line is an instance method defined in the fifteenth line, not an instance method defined in the ninth line. The reason is that substitution in the third line causes the variable p in the fourth line to reference an instance of a class R. Therefore, in the case of the source code shown in FIG. 8, it is more profitable to provide a user with a method definition in the fifteenth line, not in the fourth line. Hereinafter, a type assigned to a variable (“defined type”) is distinguished from a type of an object referenced by a variable during runtime of a program (“runtime type”). In the source code shown in FIG. 8, the defined type of the variable p is P, and the runtime type is R.

A first problem in the information display device 110 is that a user cannot recognize contents of processing of an instance method during runtime because the device 110 displays, when displaying a method definition that corresponds to a call of a specified instance method, a method definition in a defined-type of the variable.

A second problem in the information display device 110 is that it is troublesome for a user to select an appropriate method definition, if the device 110 displays, when displaying a method definition that corresponds to a call of a specified instance method, a plurality of candidates in the definition information. The reason is that there is a case in which a plurality of types correspond to a runtime type of a selected variable and a user needs to select a desired definition information from them in such a case.

Therefore, there is a need in the art to provide an information display device, an information display method, and a program that displays, when displaying a method definition that corresponds to a call of a specified instance method, definition information that corresponds to contents of processing of the instance method during runtime. Furthermore, there is also a need in the art to provide an information display device, an information display method, a program that displays, when displaying a method definition that corresponds to a call of a specified instance method, a candidate, from a plurality of candidates for definition information, that is more likely to be selected by a user at a position that is more easily selected by the user.

According to the present invention, there is provided the following.

According to a first aspect of the present invention, there is provided an information display device comprising: a memory device that has stored beforehand a type that can be referenced during runtime by a variable as reference information; a runtime type collection unit that extracts from the reference information a type that can be referenced during runtime by a variable that references a receiver object of an instance method selected by a user; a selection result display unit that displays definition information of the instance method included in the extracted type; and a sorting unit (score-assigning unit) that assigns a score to each of a type of an object generated in a code included in an application module that is newly developed module in a program and a type of an object generated in a code included in a library module that is an already implemented module in the program.

According to the present invention, there is also provided the following modes.

In a first mode, an information display device may assign to a type of an object generated in a code included in the application module a score that is greater than a score assigned to a type of an object generated in a code included in the library.

In a second mode, there is provided an information display device, wherein the selection result display unit may sort the types in descending order of their scores and display definition information of an instance method included in each type.

In a third mode, there is provided an information display device, wherein the selection result display unit may display definition information of the instance method included in a type that is assigned a greater score at a position that can be more easily seen or more easily selected by a user.

According to the present invention there is provided the following.

According to a second aspect of the present invention, there is provided an information display method comprising: referencing by a computer a memory device that has stored beforehand a type referenced during runtime by a variable as reference information to extract from the reference information a type that can be reverenced during runtime by a variable that references a receiver object of an instance method selected by a user; displaying by the computer definition information of the instance method included in the extracted type; and assigning by the computer a score to each of a type of an object generated in a code included in an application module that is a newly developed module in a program and a type of an object generated in a code included in a library module that is an already implemented module in the program.

In a fourth mode, an information display method may comprise assigning by a computer to a type of an object generated in a code included in the application module a score that is greater than a score assigned to a type of an object generated in a code included in the library module.

In a fifth mode, there is provided an information display method, wherein the displaying comprises displaying by a computer definition information of the instance method included in a type that is assigned a greater score at a position that can be more easily seen or more easily selected by a user.

According to the present invention, there is provided the following.

According to a third aspect of the present invention, there is provided a program causing a computer to execute: referencing a memory device that has stored beforehand a type referenced during runtime by a variable as reference information to extract from the reference information a type that can be reverenced during runtime by a variable that references a receiver object of an instance method selected by a user; displaying definition information of the instance method included in the extracted type; and assigning a score to each of a type of an object generated in a code included in an application module that is a newly developed module in a program and a type of an object generated in a library module that is an already implemented module in the program.

In a sixth mode, a program may cause a compute to execute a process of assigning to a type of an object generated in a code included in the application module a socre that is greater than a score assigned to a type of an object generated in a code included in the library module.

In a seventh mode, there is provided a program, wherein the displaying comprises displaying definition information of the instance method included in a type that is assigned a greater score at a position that can be more easily seen or more easily selected by a user.

In an eighth mode, there is provided an information display device, wherein the reference information is generated by at least one of CHA (Class Hierarchy Analysis), RTA (Rapid Type Analysis), VTA (Variable Type Analysis) and pointer analysis.

The present invention provides the following advantage, but not restricted thereto.

According to the present invention, there are provided an information display device, an information display method, and a program that displays, when displaying definition information of an instance method selected by a user, definition information that corresponds to contents of processing of the instance method during runtime. The reason is that it is possible to display definition information included in a type that can be referenced during runtime by a variable that references a receiver object of an instance method.

Furthermore, according to the present invention, it is possible to reduce the user's effort to select a desired type in a case where there is a plurality of candidates for a type that can be referenced during runtime by a variable that references a receiver object of an instance method. The reason is that a type that is more valuable to a user is displayed at a position that is more easily seen or selected by the user by setting priorities for a plurality of candidate types in view of whether they are generated in an application module or whether they belong to an application module upon displaying in GUI.

### BRIEF DESCRIPTION OF THE DRAWINGS

FIG. 1 is a block diagram illustrating a structure of an information display device according to a first exemplary embodiment.

FIG. 2 is a block diagram illustrating a structure of an information display device according to a second exemplary embodiment.

FIG. 3 is a diagram illustrating a form of sort information in an information display device according to an example.

FIG. 4 is a diagram illustrating another form of reference information in an information display device according to an example.

FIG. 5 is a diagram illustrating further another form of reference information in an information display device according to an example.

FIG. 6 is a flowchart illustrating an operation of an information display device according to an example.

FIG. 7 is a block diagram illustrating a structure of an information display device according to related art.

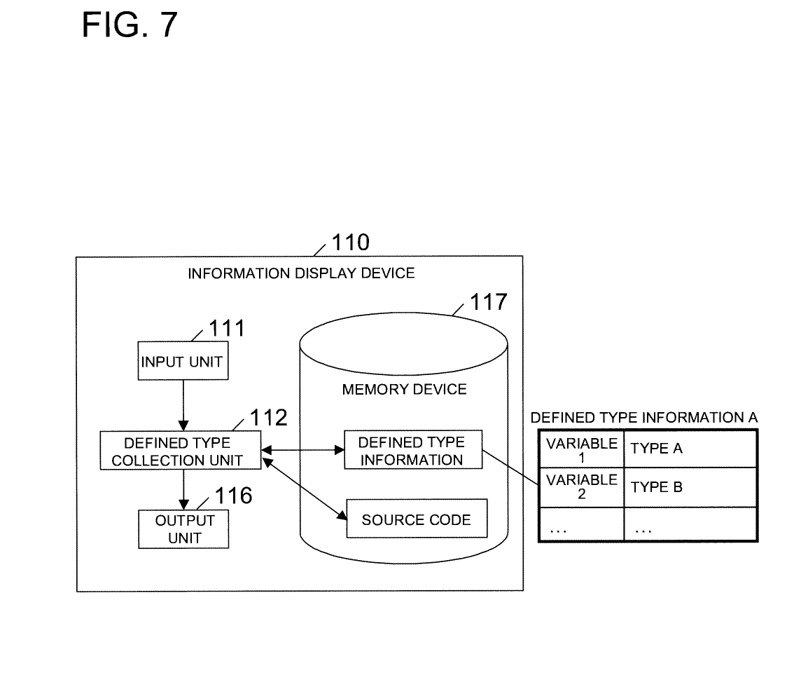

FIG. 8 is a source code of a program described in Java (registered trademark) language, which is one of object-oriented languages.

Explanation of symbols is given in the following description.

### PREFERRED MODES

### First Exemplary Embodiment

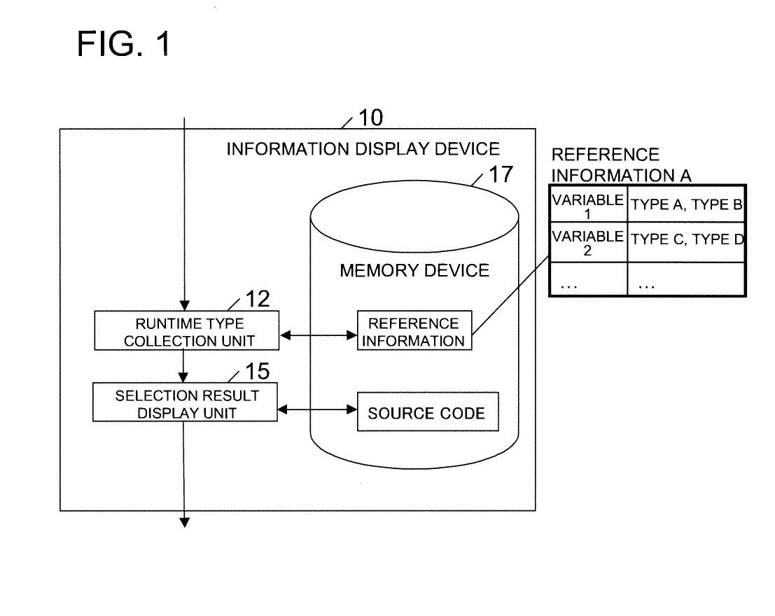

Referring to the drawings, an information display device according to a first exemplary embodiment is explained. FIG. 1 is a block diagram illustrating a structure of an information display device 10 according to the present exemplary embodiment. The information display device 10 comprises a runtime type collection unit 12, a selection result display unit 15, and a memory device 17. The memory device 17 stores a type that can be possibly referenced during runtime by a variable as reference information. The runtime type collection unit 12 extracts from the reference information a type that can be referenced during runtime by a variable that references a receiver object of an instance method. The selection result display unit 15 displays definition information of the instance method included in the extracted type.

### Second Exemplary Embodiment

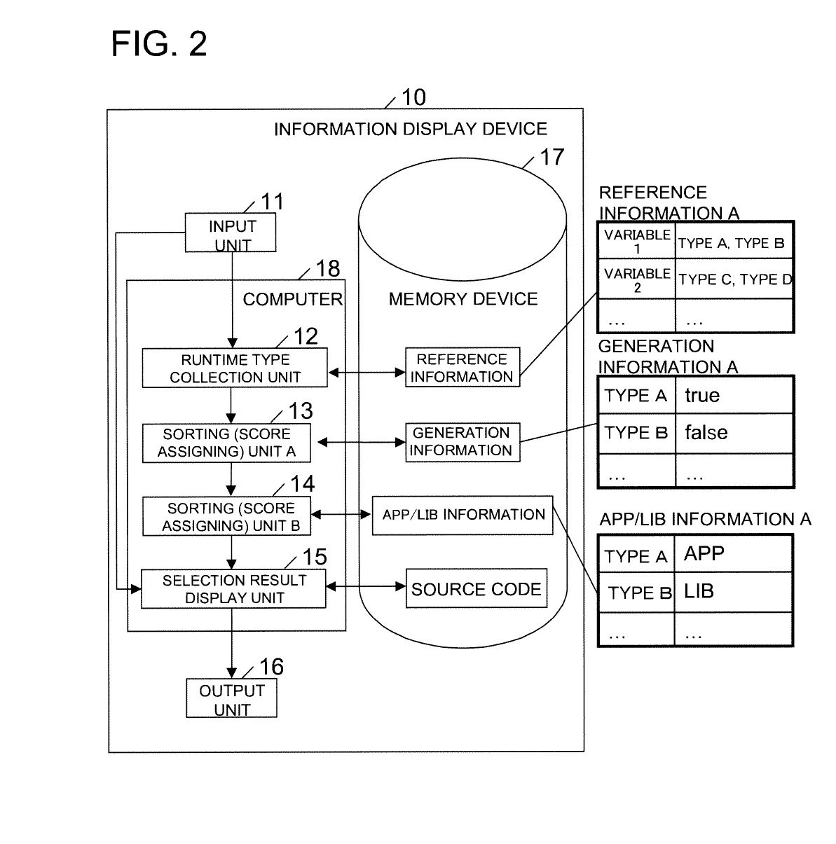

Referring to the drawings, an information display device according to a second exemplary embodiment is explained. FIG. 2 is a block diagram illustrating a structure of an information display device 10 according to the present exemplary embodiment. Referring to FIG. 2, the information display device 10 comprises a runtime type collection unit 12, a sorting (score-assigning) unit A 13, a sorting (score-assigning) unit B 14, and a selection result display unit 15.

The memory device 17 stores as reference information a set of types that can be possibly referenced during runtime by a variable included in a program. The runtime type collection unit 12 obtains from the reference information a set of types that are referenced by a variable that references a receiver object of an instance method.

The memory device 17 stores, as generation information, information that indicates whether a type is generated in an application module or not. The sorting (score assigning) unit A 13 assigns the obtained type a score based on the generation information.

The memory device 17 stores, as APP/LIB information, information that indicates whether a type belongs to an application module or belongs to a library module. The sorting (score assigning) unit B 14 assigns the type a score base on the APP/LIB information.

The selection result display unit 15 displays a type that is assigned a greater score at a position that can be more easily seen and selected by a user on a GUI and displays definition information of an instance method that corresponds to a type selected by the user.

The information display device 10 according to the present exemplary embodiment provides a user with a type that can be possibly referenced during runtime by a variable that references a receiver object of an instance method and displays a method definition of the selected type to achieve one of the objects of the present invention. Namely, it is possible to display, when displaying a method definition that corresponds to a call of a specified instance method, a method definition that corresponds to a runtime type.

Furthermore, in a case where there is plurality of candidate types that are provided to a user, a score is assigned to the types using information such as whether they are generated in a code that corresponds to an application module, or whether they belong to an application module, and outputs a type with a greater score (a type that seems more useful for a user) at a poison that is more easily seen and selected by the user on a GUI display to achieve one of the objects of the present invention. Namely, it is possible to display, when displaying a method definition that corresponds to a call of a specified instance method, a candidate, from a plurality of candidates for a method definition, that is more likely to be selected by a user at a position that is more easily selected by the user.

### FIRST EXAMPLE

Referring to the drawings, a first example of the present invention is explained in detail.

Referring to FIG. 2, an information display device 10 comprises a computer 18 that operates under control of a program, and a memory device 17 that is a memory or a hard disk drive. The computer 18 is connected to an input unit 11 that includes a keyboard, a mouse, etc., and to an output device 16 that includes a monitor etc. The computer 18 comprises a runtime type collection unit 12, a sorting (score assigning) unit A 13, a sorting (score assigning) unit B 14, and a selection result display unit 15. The memory device 17 stores reference information, generation information, APP/LIB information and a source code.

Each of these units operates in the following way. The input unit 11 receives an input that is entered by a user thorough a GUI (Graphical User Interface, not shown in FIG. 2) that is displayed in the output unit (monitor etc.) 16 for viewing and editing a source code. In the present example, the input unit 11 detects that a user has selected a call part of an instance method thorough a viewing GUI and instructed to display the definition information.

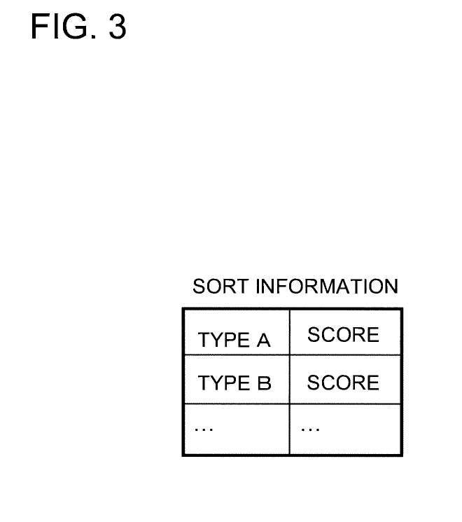

When the runtime type collection unit 12 receives call information of an instance method selected by the input unit 11, the runtime type collection unit 12 reads, from the reference information, runtime type information for a variable that references a receiver object of the instance method. The runtime type collection unit 12 generates sort information as shown in FIG. 3 from the read type information and sends the sort information to sorting (score assigning) unit A 13.

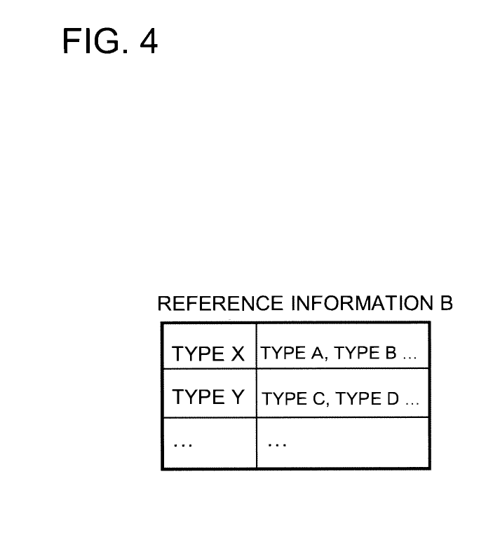

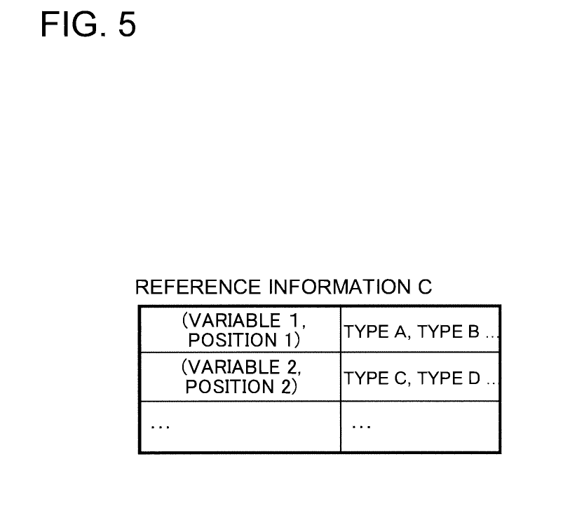

The reference information A is a concrete example of reference information stored in the memory device 17. The reference information A is a table that relates a variable with a set of types that can be referenced by the variable during runtime. This reference information A can be generated, for example, by CHA (Class Hierarchy Analysis), RTA (Rapid Type Analysis), VTA (Variable Type Analysis), pointer analysis, etc. In particular, reference information obtained through CHA or RTA has a structure of reference information shown in FIG. 4 On the other hand, reference information obtained through flow-sensitive pointer analysis has a structure of reference information C shown in FIG. 5. A processing based on the reference information B or the reference information C will be described later.

The sort information includes score information for sorting in addition to the type information. It is assumed that an initial value of a score is zero when it is generated.

When the sorting (score assigning) unit A 13 receives a sort information, the sorting (score assigning) unit A 13 obtains, from the generation information A, generation information for each type included in the sort information. If a value for a type is true, the sorting (score assigning) unit A 13 adds a value (for example two) to a corresponding score in the sort information. After the process, the sorting (score assigning) unit A 13 sends the sort information to the sorting (score assigning) unit B 14.

A concrete example of generation information is shown as generation information A. In this example, the program can be divided into an application module (APP) and a library module (LIB). Application modules and library modules are managed separately, for example, in a widely used program development environment Eclipse. The generation information A indicates whether each type is generated by an application module of the program (true) or not (false). This generation information can be generated by collecting types that are generated by an object generation instruction (for example a new instruction) that appears in a source code of the application module. In the present example, a generation information has been stored beforehand in the memory device 17.

When the sorting (score assigning) unit B 14 receives the sort information, the sorting (score assigning) unit B 14 obtains, from APP/LIB information stored in the memory device 17, APP/LIB information for each type included in the sort information. If a type is included in an application module (APP), the input unit 11 add a value (for example one) to a corresponding score in the sort information. After the process, the sorting (score assigning) unit B 14 sends the sort information to the selection result display unit 15.

A concrete example APP/LIB information is shown as APP/LIB information A. As already described, the program is divided into application modules and library modules and the APP/LIB information A stores a pair of type and value (APP or LIB) that indicates whether a type belongs to an application module (APP) or a library module (LIB).

When the selection result display unit 15 receives the sort information, the selection result display unit 15 stores types included in the sort information in a list type data structure and, after sorting the types in descending order of their scores, sends the sorted list to the output device 16. Furthermore, the selection result display unit 15 receives a type that is selected by a user from the input unit 11 and reads a class definition that corresponds to the type from the source code. The selection result display unit 15 outputs a method definition that is included in the class definition and corresponds to the selected instance method on a GUI display through the output device 16.

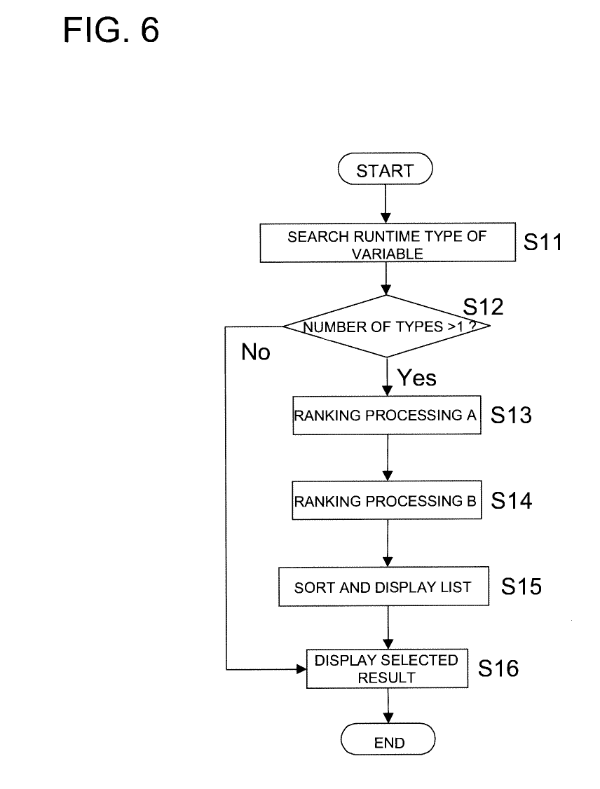

Referring to a flowchart shown in FIG. 6, a total operation of the information display device 10 according to the present example is explained in detail.

When the input unit 11 detects an input from a user through a GUI, a call of an instance method in a source code that is displayed on the GUI is selected, and an input that requests to display its definition, the input unit 11 sends information on the selected instance method to the runtime type collection unit 12. The information on the instance method includes: a position where the instance method appears in the source code, a name of a variable name that references the receiver object, a string (signature) that represents the method, etc. When the runtime type collection unit 12 receives the information of the instance method, the runtime type collection unit 12 reads type information (runtime type) for a variable name that references a receiver object of the instance method from reference information stored in the memory device 17.

As described above, the reference information can be generated, for example, by CHA, RTA, VTA or pointer analysis. In particular, through CHA or RTA, instead of a table that shows a relation between a variable and a set of types, a table that shows relation between a type and a set of types is obtained (reference information B in FIG. 4). In this case, a set of types is obtained that includes a type of a variable that references a receiver object of the selected instance method. Since a variable is distinguished by its position in the program in flow-sensitive pointer analysis, a table that shows relation between a pair of variable and position and a set of types is obtained as shown as reference information C in FIG. 5. In this case, a set of types is obtained based on a variable that references a receiver object of the instance method and a position where the variable appears in the program.

The runtime type collection unit 12 generates sort information shown in FIG. 3 using a set of types that represents a runtime time of a variable that references the receiver object. Variables A and B in the first column correspond respectively to each of the elements in a set of runtime variables. Score in the second column is an integer and set to zero as an initial value.

If two or more (i.e., >1) elements are included in the set of runtime type set of a variable that references the receiver object (Yes in step S12), the runtime type collection unit 12 sends generated sort information to the sorting (score assigning) unit A 13. If the number of elements is one (No in step S12), the runtime type collection unit 12 sends sort information directly to the selection result display unit 15 because sort is not necessary. If the number of elements is zero, an error message is presented and the processing ends at this point because a problem such as a failure to analyze a runtime type might have occurred.

When the sorting (score assigning) unit A 13 receives the sort information, the sorting (score assigning) unit A 13 obtains, from the generation information stored in the memory device 17, generation information for each type. If a value for each type in the generation information is true, object of the type is generated in an application module of the program. If values respectively for the types in the generation information are true, 2 is added to the corresponding score for the variable in the sort information (step S13). In the present example, it is judged that information with a greater score is more likely to be valuable to a user. Namely, in the present example, it is assumed that a type generated in an application module is more valuable to a user than a type generated in a library module. After the sorting (score assigning) unit A 13 has processed all types in the sort information, the sorting (score assigning) unit A 13 sends the sort information to the sorting (score assigning) unit B 14.

When the sorting (score assigning) unit B 14 receives the sort information, the sorting (score assigning) unit B 14 obtains, from APP/LIB information stored in the memory device 17, APP/LIB information for each type. If a value corresponding to a type is APP, the type definition belongs to an application module. If a value corresponding to a type is LIB, the type definition belongs to a library module. The sorting (score assigning) unit B 14 checks value in the APP/LIB information for each type in the sort information, and, if the value is APP, adds 1 to the score for the variable (step S14). After the sorting (score assigning) unit B 14 has processed all types, the sorting (score assigning) unit B 14 sends the sort information to the selection result display unit 15. In the present example, it is assumed that a type definition that belongs to the application module is more valuable to a user than a type definition that belongs to the library module.

As a result of the ranking processing A (step S13) and the ranking processing B (step S14), a type that is generated in the application module and whose type definition belongs to the application module has a score of 3 (highest), a type that is generated in the application module and whose type definition belongs to a library module has a score of 2, a type that is not generated in the application module and whose type definition belongs to the application module has a score of 1, and a type other than those has a score of zero. A method of assigning score(s) is not necessarily the same as the one in the present exemplary embodiment. In the present example, a method of assigning score is shown as a preferable example. Therefore, the scores added in steps S13 and S14 may be modified to change the priorities.

When the selection result display unit 15 receives the sort information, the selection result display unit 15 sorts the types in the sort information in a descending order of their scores (a type with a greater score is located at a higher position), and display on a GUI a list of type information according to the sorted order (step S15). A list item for displaying a type at a high rank may preferably be focused as default. The default focusing makes it possible for a user to complete selection by a simple operation such as pushing an enter key. The style of display is not necessarily a list style. It is sufficient that a type with a greater score is more easily seen by a user. Therefore, after the sort, instead of displaying a GUI display in the descending order of scores, or with such a GUI display, a type with a greater score may be displayed with a greater font size, with a more easily seen color, or, in a more emphasized style. When the selection result display unit 15 receives from the input unit 11 information on which type is selected by a user from the list of types presented above, the selection result display unit 15 extracts definition information that corresponds to the selected type from a source code stored in the memory device 17. Furthermore, the selection result display unit 15 sends to the output unit 16 a method definition that is included in the extracted type definition and corresponds to the selected instance method. The output unit 16 displays the received method definition on a GUI display (step S16). Since an object-oriented language supports inheritance, there may be a case where a method definition for the selected instance method is not included in the extracted type definition information. Therefore, in such a case, a parent type for the extracted type should be searched base on the inheritance tree to display a method definition included in the type definition for the parent nearest to the extracted type (there is a shortest path to the extracted type in the inheritance tree).

Even in a case where there is a plurality of runtime types, the processing in the sorting (score assigning) unit A 13 and sorting (score assigning) unit B 14 may be omitted, the runtime type collection unit 12 may send the sort information directly to selection result display unit 15, and the selection result display unit 15 may display the type information regardless of the scores. The processing (step S13) in the sorting (score assigning) unit A 13 and the processing (step S14) in the sorting (score assigning) unit B 14 may be performed in a reverse order, or they may be performed in parallel and scores assigned in each processing may be added to determine a score for each type. Furthermore, any one of the processings in the sorting (score assigning) unit A 13 and sorting (score assigning) unit B 14 may be omitted.

Next, an effect of the information display device according to the present invention is explained. The information display device 10 is adapted to display, when displaying a definition of an instance method, not a defined type of a variable that references a receive object of the instance method, but a runtime information extracted from reference information. Therefore, the information display device 10 can display definition information that corresponds to a runtime type of an instance method. Furthermore, in the present example, the information display device 10 is adapted to assign a score to each of types corresponding to a runtime type to display a list of candidate types in a way that a more valuable type to a user is displayed in a form that is more readily seen or in a form that is more readily selected. Therefore, the user can select a necessary type and refer necessary definition information with little effort.

### SECOND EXAMPLE

Referring to the drawing, an information display device according to a second example of the present invention is explained.

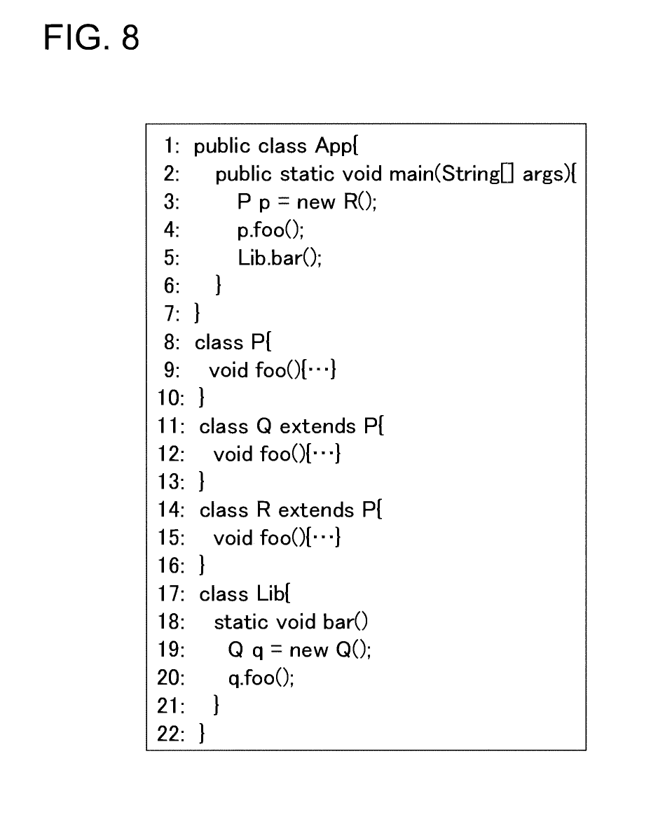

An operation of the information display device 10 according to the present example is explained using a program shown in FIG. 8 as an example. It is assumed that a user has requested definition information corresponding to “p.foo( )” on the fourth line. It is also assumed that App, Q and R are a type that belongs to an application module, and P and Lib are a type that belongs to a library module. Since R is generated by new in the third line of the class App, generation information is true only for type R.

Reference information for a set of types (runtime types) corresponding to a variable p that appears on the fourth line is explained. Reference information varies according to which analysis of CHA, RTA, VTA and pointer analysis is used for generating the information. In the case of CHA, a set of types includes {P, Q, R}. In the case of RTA, a set of types includes {Q, R}. In the case of VTA or pointer analysis, a set of types includes only {R}. As an example, a case where CHA is used is explained. In this case, the set of types corresponding to the variable p is {P, Q, R}.

The runtime type collection unit 12 obtains reference information for a variable that references a receiver object of p.foo( ) The variable is p, and the corresponding reference information is {P, Q, R}.

The sorting (score assigning) unit A 13 assigns a score to each of P, Q and R using the generation information. As described above, only R is generated in the application module (App). Therefore, P is assigned a score of zero, R is assigned a score of zero, and R is assigned a score of 2.

The sorting (score assigning) unit B 14 assigns a score to each of P, Q and R using APP/LIB information. Since P belongs to LIB and Q and R belong to APP, P is assigned a score of zero and Q and R are assigned a score of 1. The resultant score is added to the score assigned by the sorting (score assigning) unit A 13, resulting in that P is assigned a score of zero, Q is assigned a score of 1, and R is assigned a score of 3.

In this case, the selection result display unit 15 displays R at a position that is most easily seen, Q at a position that is less easily seen, and P at a position that is less easily seen than a position in which Q is displayed. In the case of RTA, R is displayed in a position that is more easily seen than a position where Q is displayed. The selection result display unit 15 displays R at a position that is most easily seen and most easily selected. Referring to the third line, a type of the object referenced during runtime by the variable p on the fourth line is R. Therefore, the definition information that corresponds to a processing of an instance method during runtime is displayed at a position that is most easily seen by a user.

The selection result display unit 15 displays on a GUI display a definition on the ninth line if P is selected by a user, a definition on the twelfth line if Q is selected, and a definition on the fifteenth line if R is selected.

### INDUSTRIAL APPLICABILITY

The present invention is applicable to a program visualization function in a program development environment that supports developing a program. Moreover, the present invention is applicable to a program visualization tool that supports visualizing a program.

Entire disclosure of the above Non-Patent Document is incorporated by reference in the present application.

Within the entire disclosure of the present invention (including the claims), and based on its basic technological idea, exemplary embodiments or examples of the present invention may be changed and/or adjusted. Also it should be noted that in the scope of the claims of the present invention, any combinations or selections of various elements disclosed herein are possible. That is, needless to say, it is understood by those skilled in the art that various changes or modifications can be made to the present invention based on the disclosure of the present invention including the claims and the technological idea of the present invention.

1.-17. (canceled)

18. An information display device, characterized by comprising:
a memory device that has stored beforehand a type that can be referenced during runtime by a variable as reference information;
a runtime type collection unit that extracts from said reference information a type that can be referenced during runtime by a variable that references a receiver object of an instance method selected by a user;
a selection result display unit that displays definition information of said instance method included in the extracted type; and
a sorting unit that assigns a score to each of a type of an object generated in a code included in an application module that is a newly developed module in a program and a type of an object generated in a code included in a library module that is an already implemented module in the program.

19. The information display device according to claim 18, wherein said sorting unit assigns to a type of an object generated in a code included in said application module a score that is greater than a score assigned to a type of an object generated in a code included in said library module.

20. The information display device according to claim 18, wherein the selection result display unit sorts the types in descending order of their scores and displays definition information of an instance method included in each type.

21. The information display device according to claim 18, characterized in that the selection result display unit displays definition information of the instance method included in a type that is assigned a greater score at a position that can be more easily seen or more easily selected by a user.

22. An information display method, characterized by comprising:
referencing by a computer a memory device that has stored beforehand a type referenced during runtime by a variable as reference information to extract from said reference information a type that can be reverenced during runtime by a variable that references a receiver object of an instance method selected by a user;
displaying by the computer definition information of said instance method included in the extracted type; and
assigning by the computer a score to each of a type of an object generated in a code included in an application module that is a newly developed module in a program and a type of an object generated in a code included in a library module that is an already implemented module in the program.

23. The information display method according to claim 22, further comprising assigning by a computer to a type of an object generated in a code included in said application module a score that is greater than a score assigned to a type of an object generated in a code included in said library module.

24. The information display method according to claim 22, wherein said displaying, displaying, comprises by a computer definition information of the instance method included in a type that is assigned a greater score at a position that can be more easily seen, or more easily selected by a user.

25. A program, characterized by causing a computer to execute:
referencing a memory device that has stored beforehand a type referenced during runtime by a variable as reference information to extract from said reference information a type that can be reverenced during runtime by a variable that references a receiver object of an instance method selected by a user;
displaying definition information of said instance method included in the extracted type; and
assigning a score to each of a type of an object generated in a code included in an application module that is a newly developed module in a program and a type of an object generated in a code included in a library module that is an already implemented module in the program.

26. The program according to claim 25, further comprising causing a computer to execute a process of assigning to a type of an object generated in a code included in said application module a score that is greater than a score assigned to, a type of an object generated in a code included in said library module.

27. The program according to claim 25, wherein said displaying comprises, displaying definition information of the instance method included in a type that is assigned a greater score at a position that can be more easily seen or more easily selected by a user.

28. The information display device according to claim 18, wherein said reference information is generated by at least one of CHA (Class Hierarchy Analysis), RTA (Rapid Type Analysis), VTA(Variable Type Analysis) and pointer analysis.

29. The information display device according claim 19, wherein said selection result display unit sorts the types in descending order of their scores and displays definition information of an instance method included in each type.

30. The information display device according claim 19, wherein the selection result display unit displays definition information of the instance method included in a type that is assigned a greater score at a position that can be more easily seen or more easily selected by a user.

31. The information display method according to claim 23, wherein said displaying comprises displaying by a computer definition information of the instance method included in a type that is assigned a greater score at a position that can be more easily seen or more easily selected by a user.

32. The program according to claim 26, wherein said displaying comprises displaying definition information of the instance method included in a type that is assigned a greater score at a position that can be more easily seen or more easily
